(19) United States
(12) Patent Application Publication
(10) Pub. No.: US 2015/0029947 A1
(43) Pub. Date: Jan. 29, 2015

(54) SYSTEM FOR SUPPORTING LOGICAL MOBILE NODES ON A MOBILE ACCESS GATEWAY

(71) Applicant: Cisco Technology, Inc., San Jose, CA (US)

(72) Inventors: Srinath Gundavelli, San Jose, CA (US); Sanjay Kumar, Bangalore (IN); Kent K. Leung, Palo Alto, CA (US); David Mindel, Jenkintown, PA (US); Julie Ann Connary, Avon, CO (US)

(73) Assignee: Cisco Technology, Inc., San Jose, CA (US)

(21) Appl. No.: 13/952,848

(22) Filed: Jul. 29, 2013

(51) Int. Cl. H04W 8/26

(52) U.S. Cl. CPC H04W 8/26
USPC 370/329

(57) ABSTRACT

In one embodiment, a mobile access gateway (MAG) includes a processor, a communications interface, and logic. The communications interface is configured to communicate with at least one mobile network and at least one local mobility anchor. The logic includes a mobile node logical instance module and an selection module. The mobile node logical instance module is configured to cooperate with the processor to create a first logical instance of a first mobile node on the MAG, and the address selection module is configured to cooperate with the processor to configure an egress roaming interface for the MAG.

The disclosure relates generally to network communications and, more particularly, to enabling instances of logical mobile nodes to be configured as collocated entities on a mobile access gateway.

### BACKGROUND

Many networks support multiple customers behind a Proxy Mobile IPv6 (PMIPv6) mobile access gateway (MAG). As will be appreciated by those skilled in the art, a MAG typically serves one or more mobile nodes attached to its access links. A mobile node is generally referred to as a mobile router when there is at least one mobile network attached to the mobile node. Each customer behind a MAG generally has a dedicated mobile router, e.g., a mobile node with at least one network attached to it, which performs access authentication and obtains delegated mobile network prefixes for its associated mobile networks. The mobile networks attached to the mobile router generally belong to a single customer. A MAG on an access link identifies the mobile router and provides mobility management support on its behalf. The MAG also registers the mobile router and its mobile network prefixes with a local mobility anchor. Both the MAG and the local mobility anchor in the network may provide mobility management support to associated mobile networks, and effectively ensure Internet Protocol (IP) reachability to those mobile networks.

### BRIEF DESCRIPTION OF THE DRAWINGS

The disclosure will be readily understood by the following detailed description in conjunction with the accompanying drawings in which:

FIG. 1 is a block diagram representation of an overall network that includes a mobile access gateway (MAG) on which logical instances of mobile nodes, e.g., mobile routers, are collocated in accordance with an embodiment.

FIG. 2 is a block diagram representation of a first overall network that includes a MAG on which logical instances of mobile nodes, e.g., logical instances of mobile routers, are collocated and in which an egress link to application services on a network may be shared in accordance with an embodiment.

FIG. 3 is a block diagram representation of an overall network that includes a MAG on which logical instances of mobile nodes, e.g., logical instances of mobile routers, are collocated and in which an egress link to application services on a network may be dedicated in accordance with an embodiment.

FIG. 4 is a block diagram representation of a second overall network that includes a MAG on which logical instances of mobile nodes, e.g., logical instances of mobile routers, are collocated and in which an egress link to application services on a network may be shared in accordance with an embodiment.

FIG. 5 is a diagrammatic representation of a MAG in accordance with an embodiment.

FIG. 6 is a diagrammatic representation of a messaging extension suitable for indicating the existence of a logical instance of a mobile node, e.g., a logical instance of a mobile router, on a MAG in accordance with an embodiment.

### DESCRIPTION OF EXAMPLE EMBODIMENTS

### General Overview

According to one aspect, a mobile access gateway (MAG) includes a processor, a communications interface, and logic. The communications interface is configured to communicate with at least one mobile network and at least one local mobility anchor. The logic includes a mobile node logical instance module and an address selection module. The mobile node logical instance module is configured to cooperate with the processor to create a first logical instance of a first mobile node on the MAG, and the address selection module is configured to cooperate with the processor to configure an egress roaming interface for the MAG. Typically, customer traffic from a mobile network is maintained separately. That is, two logical mobile nodes or routers may be configured on a MAG, but mobile network traffic corresponding to each logical mobile node is effectively segregated.

### Description

Proxy Mobile IPv6 (PMIPv6) generally provides network-based Internet Protocol (IP) mobility management to mobile nodes in an overall communications network. Entities within IPv6 typically include mobile access gateways (MAGs), local mobility anchors (LMAs), and mobile nodes. As will be appreciated by those skilled in the art, a mobile node is generally an Internet Protocol (IP) host whose mobility is effectively managed by a network. A mobile node may include IPv6 and/or IPv4 protocol stacks. PMIPv6 base technology is described in RFC standards, e.g., RFC 5213 entitled “Proxy Mobile IPv6” and RFC 5844 entitled “IPv4 Support for Proxy Mobile IPv6,” which are incorporated herein by reference in their entireties.

A MAG, which may be an access router, generally performs mobility-related signaling on behalf of mobile nodes that are substantially attached to access links associated with the MAG. In general, a MAG is configured to obtain an IP address for a mobile node from an LMA, to assign the IP address to the mobile node, to retain the IP address for the mobile node as the mobile node roams across different MAGs, and to tunnel traffic from the mobile node to the LMA. In one embodiment, a MAG has the ability to configure logical instances of mobile nodes, e.g., mobile routers, as collocated entities on the MAG. When logical instances of mobile nodes are collocated entities on a MAG, a dynamic collocated care-of-address (CCOA) mode functionality may be introduced as part of a MAG. In addition, when a logical instance of a mobile node and a MAG are collocated, they are effectively not separated by a layer-2, or L2, access, and are substantially always present.

In one embodiment, a MAG on which logical instances of mobile nodes may be configured may also include interfaces which are substantially dedicated to support physical mobile nodes. That is, a MAG may support both logical mobile nodes and physical mobile nodes by creating logical instances of mobile nodes on the MAG, as well as interfacing with physical mobile nodes.

A MAG may include multiple roaming interfaces which allow the flexibility for different egress or upstream interfaces to be selected for use in routing traffic. As will be appreciated by those skilled in the art, a roaming interface is generally an egress link that allows the MAG to connect to a network, or an egress interface of a MAG that faces a network. By way of example, a MAG may be connected to 3G and wireless local area network (WLAN) links, and network interfaces that connect the MAG to the 3G and WLAN links may be roaming interfaces. A MAG that includes multiple roaming interfaces may generally facilitate the identification of where particular traffic is coming from, e.g., where particular traffic originates. The ability to effectively identify where traffic is coming from allows network usage to be appropriately billed, e.g., originators of traffic may pay for the amount of network bandwidth used. In addition, the ability to effectively identify where traffic is coming from allows for certain traffic to be prioritized. For example, a logical instance of a mobile node may be associated with a satellite, and the ability to identify traffic as being associated with a satellite allows the traffic to be prioritized.

By configuring multiple logical mobile node or mobile router instances substantially directly on a MAG, the use of physical router boxes dedicated to specific customers may effectively be eliminated. As a result, an owner or operator of a mobile network system may deploy a single MAG to support multiple customers.

In general, customer traffic associated with a mobile network may be maintained separately. For example, when two or more logical mobile nodes or routers are configured on a MAG, mobile traffic that corresponds to each of the logical mobile nodes or routers may effectively be segregated, or kept substantially separate.

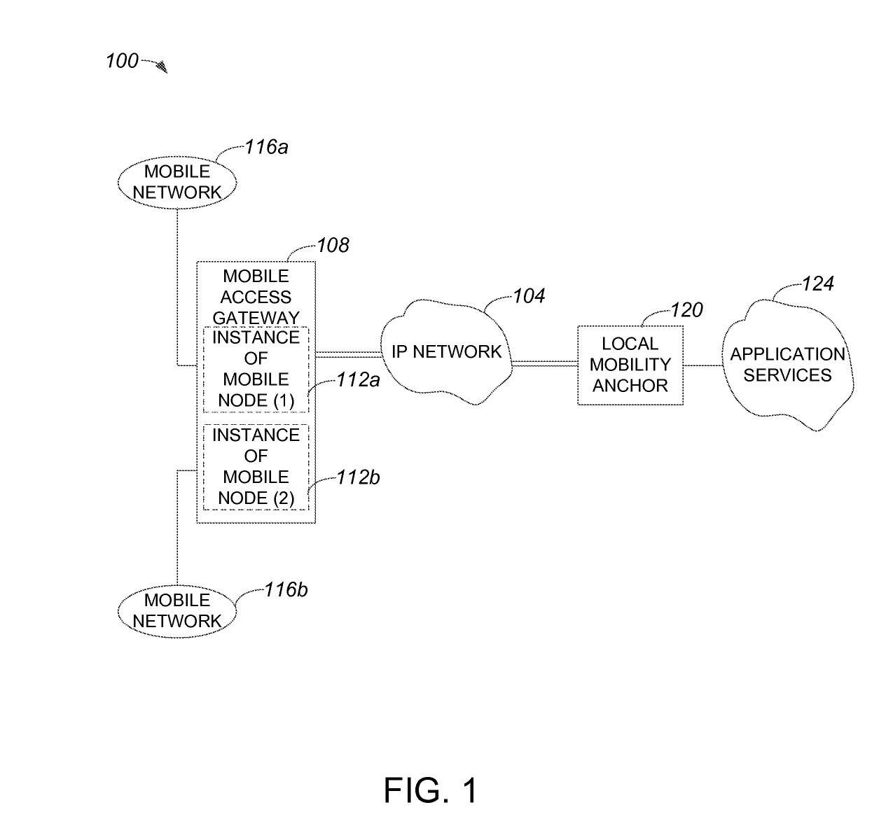

Referring initially to FIG. 1, an overall network that includes a MAG on which a logical instance of a mobile node is collocated will be described in accordance with an embodiment. An overall network 100 includes an IP network 104 that is in communication with a MAG 108 and an LMA 120.

MAG 108 may generally be associated with any number of mobile networks 116a, 116b, and generally supports mobile nodes (not shown) that are effectively attached to MAG-enabled interfaces. MAG 108 is configured to obtain an IP address from LMA 120, and to assign the IP address to a physical mobile node (not shown) that may be a part of a mobile network 116a, 116b. Once the IP address is assigned to a physical mobile node (not shown), the IP address is generally retained by the physical mobile node. MAG 108 is also configured to tunnel traffic from a physical mobile node (not shown) to LMA 120, as described, for example, in RFC 5213 and RFC 5844.

LMA 120 may be configured to be a home agent for physical mobile nodes (not shown) within overall network 100. In the described embodiment, LMA 120 and MAG 108 may communicate using a PMIPv6 mobility management protocol. It should be appreciated, however, that IP network 104, e.g., a transport network between LMA 120 and MAG 108, is not limited to being IPv6. For example, the transport network between LMA 120 and MAG 108 may be IPv4. In general, the network between LMA 120 and MAG 108 may be IPv4 or IPv6, e.g., mobile nodes attached to MAG 108 may be IPv4-enabled and/or IPv6-enabled.

A logical instance of a mobile node 112a is created on MAG 108 and associated with mobile network 116a such that logical instance of mobile node 112a and MAG 108 are effectively a single element, e.g., node, within overall network 100. Similarly, a logical instance of mobile node 112b is created on MAG 108 and associated with mobile network 116b such that logical instance of mobile node 112b and MAG 108 are also effectively a single element within overall network 100. It should be appreciated that once logical instances of mobile nodes 112a, 112b are created, logical instances of mobile nodes 112a, 112b are substantially always present on MAG 108 until command line interfaces (CLIs) associated with logical instances of mobile nodes 112a, 112b are deactivated. Typically, MAG 108 may detect when physical mobile nodes are attached to its links based on Access Authentication and/or from received IP network triggers obtained from the physical mobile nodes. It should be appreciated that when mobile nodes are logical instances of mobile nodes 112a, 112b, the detection of logical instances of mobile nodes 112a, 112b is generally not based on IP network triggers but is, instead, based on a CLI configuration.

When logical instance of mobile node 112 is configured on MAG 108, MAG 108 may identify the associated logical mobile node from the configuration. The configuration also provides an identity of the logical mobile node. MAG 108 may use this identity to obtain a profile for the mobile node from authentication, authorization, and accounting (AAA), or from a local policy store. A policy profile of a mobile node may contain, but is not limited to containing,

The identity of logical instance of mobile node 112a and the identity of logical instance of mobile node 112b are substantially always known within network 100, and are configured when logical instance of mobile node 112a and logical instance of mobile node 112b, respectively, are created. In one embodiment, the identity includes a mobile node identifier, e.g., MN-identifier, a media access control (MAC) address that may be used in PMIPv6 signaling messages, a designated home-interface, and/or a mobile network interface.

A primary IPv4 home address and/or home network prefix assigned by LMA 120 for a logical instance of mobile node 112a, 112b may be configured, e.g., statically configured, on the home interface of a physical mobile node (not shown) associated with the logical instance of mobile node 112a, 112b. Further, mobile network prefixes assigned by LMA 120 for delegated mode use may also be configured, e.g., statically configured, on designated interfaces associated with mobile networks 116a, 116b. MAG 108 may register mobile network prefixes, associated with a local mobile node, with LMA 120. A home interface is an interface on which a home address of a physical mobile node is configured, while a mobile-network interface is an interface on which a mobile network is configured.

Mobile networks 116a, 116b may be IPv4 and/or IPv6 mobile networks. It should be appreciated that any number of mobile networks 116a, 116b may generally be included in overall network 100. Mobile nodes (not shown) that are associated with mobile networks 116a, 116b may access application services 124 through MAG 108, IP network 104, and LMA 120. It should be appreciated that IP nodes in mobile networks 116a, 116b that belong to a specific customer may be able to access their respective customer-specific networks attached to LMA 120, and that LMA 120 may route customer traffic substantially directly to appropriate home networks.

In one embodiment, signaling to LMA 120 may be initiated based on a CLI for logical instance of mobile node 112a or a CLI for logical instance of mobile node 112b. For example, PMIPv6 signaling to LMA 120 may be initiated based on a CLI for a logical instance of mobile node 112a, 112b. In another embodiment, traffic from a given customer network may trigger PMIPv6 signaling, particularly when ingress interfaces are effectively marked with a customer and/or logical mobile node identity.

As will be appreciated by those skilled in the art, a logical instance of mobile node 112a, 112b may acquire a COA, e.g., a CCOA, which may effectively be used to forward packets to logical instances of mobile nodes 112a, 112b. A COA is typically the IP address of MAG 108 on its egress interfaces or links. In one embodiment, when an IP address for an interface is obtained dynamically, a COA may be a Dynamic COA. When MAG 108 has multiple egress links, MAG 108 may have multiple COAs, and may set up tunnels with LMA 120 using these COAs. The CCOA acquired by a logical instance of mobile node 112a, 112b may be an IP address dynamically acquired, as for example using a Dynamic Host Configuration Protocol (DHCP) on an Ethernet interface or using a protocol on a point-to-point serial interface. In the described embodiment, the functionality which allows logical instances of mobile nodes 112a, 112b to acquire a CCOA is provided by MAG 104. It should be understood that logical instances of mobile nodes 112a, 112b generally do not directly see or use COAs, and that traffic from mobile networks 116a, 116b may be tunneled by MAG 108, where the COAs are tunnel endpoints.

It should be understood that if an egress interface of MAG 108 is effectively dedicated to a single logical instance of mobile node 112a, 112b, then a COA, which is an IP address on that egress interface, may be used to set up a tunnel with LMA 120 substantially only for that single logical instance of mobile node 112a, 112b. Alternatively, if an egress interface of MAG 108 is shared, then with multiple logical instances of mobile nodes 112a, 112b may undergo a tunnel setup using the COA of the egress interface.

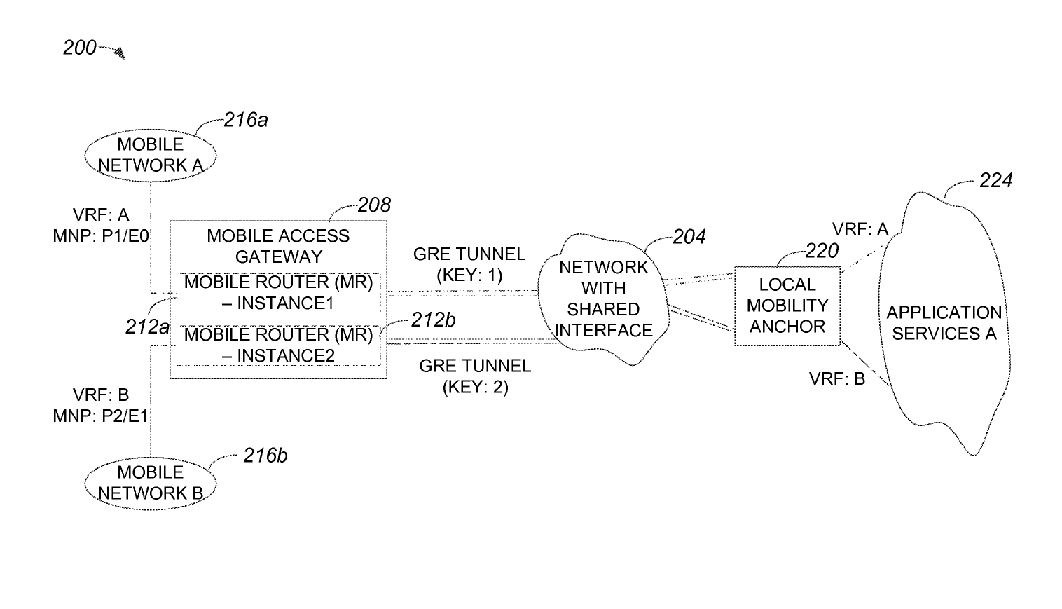

A MAG may generally include more than one logical instance of a mobile node such as a mobile router. When a MAG supports more than one logical instance of a mobile node, egress links may either be shared by different mobile network or dedicated to particular mobile networks. FIG. 2 is a block diagram representation of a first overall network that includes a MAG on which logical instances of mobile nodes, e.g., logical instances of mobile routers, are collocated and in which an egress link that allows access to application services on a network may be shared in accordance with an embodiment. An overall network 200 includes a MAG 208 that includes a logical instance of a mobile router 212a that is associated with a mobile network “A” 216a and a logical instance of a mobile router 212b that is associated with a mobile network “B” 216b. Mobile network “A” 216a has an ingress interface associated with logical instance of mobile router 212a, while mobile network “B” 216b has an ingress interface associated with logical instance of mobile router 212b. Each mobile network ingress interface is also associated with a specific tunnel, or generic routing encapsulation (GRE) key.

A network with a shared interface 204, as for example a 3G network with a shared interface, may be accessed through the tunnels that are specific to each mobile network ingress interface. Through network with a shared interface 204, egress links to an LMA 220 may be dedicated to tenants in each mobile network 216a, 216b. In one embodiment, two home networks may be associated with LMA 220. Through LMA 220, application services 224 for mobile network “A” 216a and for mobile network “B” 216b may be accessed. It should be appreciated that virtual routing and forwarding (VRF) tables may be utilized to facilitate access to application services 224.

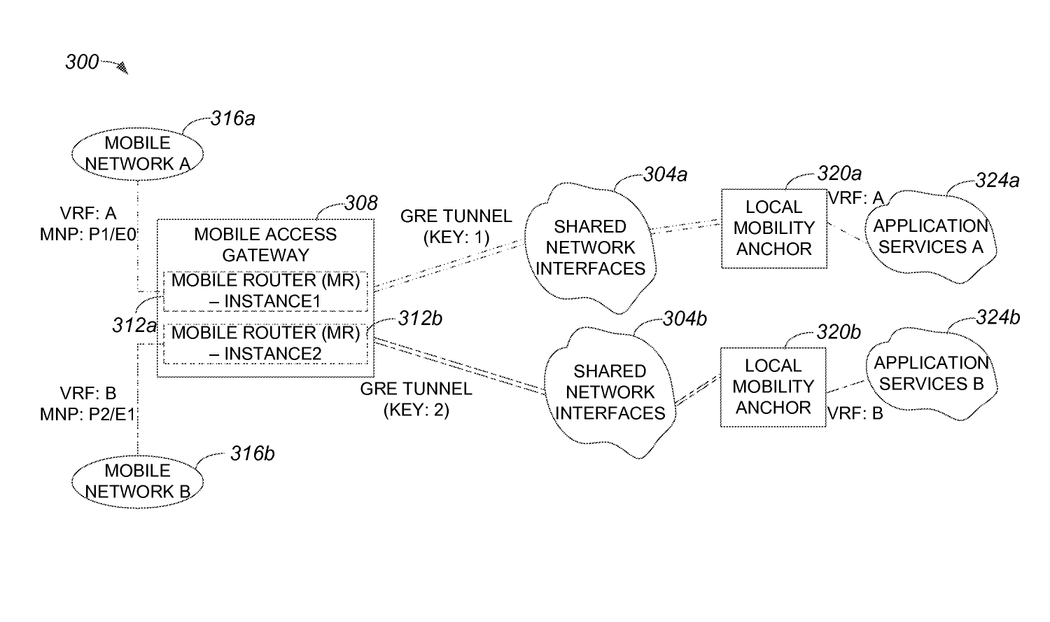

FIG. 3 is a block diagram representation of an overall network that includes a MAG on which logical instances of mobile nodes, e.g., logical instances of mobile routers, are collocated and in which an egress link to application services on a network may be dedicated in accordance with an embodiment. An overall network 300 includes a MAG 308 that has a logical instance of a mobile router 312a that is associated with a mobile network “A” 316a and a logical instance of a mobile router 312b that is associated with a mobile network “B” 316b. Mobile network “A” 316a has an ingress interface associated with logical instance of mobile router 312a, while mobile network “B” 316b has an ingress interface associated with logical instance of mobile router 312b. As shown, each mobile network ingress interface is also associated with a specific tunnel, or GRE key.

A network with a shared interface 304a, e.g., an egress 3G link, is dedicated to a tenant associated with mobile network “A” 316a, and allows the tenant to communicate with an LMA 320a to obtain application services 324a. Similarly, a network with a shared interface 304b, e.g., an egress 3G link, is dedicated to a tenant associated with mobile network “B” 316b, and allows the tenant to communicate with an LMA 320b to obtain application services 324b. It should be appreciated that while an egress link has generally been described as a 3G link, an egress link is not limited to being a 3G link. By way of example, an egress link may be a 4G link or a satellite link.

MAG 308 may generally use multiple egress interfaces for internet connectivity. By way of example, MAG 308 may achieve internet connectivity using a 4G LTE network and an IEEE 802.11-based WLAN network. Each shared interface 304a, 304b, or egress interface, may be dedicated to a single logical mobile router or customer such that substantially only traffic associated with that single logical mobile router or customer may use and, thus pay for the service associated with, a link associated with that specific shared interface 304a, 304b. Such a link may be a tunnel, and each logical mobile instance of mobile router 312a, 312b may have its own link.

When a tenant has a dedicated egress link, the ability to determine the amount of resources used by the tenant may be enhanced. As a result, it may be possible to charge customers of mobile networks 316a, 316b based upon the amount of resources used by the tenant, since the egress link dedicated to the tenant is readily identifiable. For example, when logical instance of mobile node 312a may choose a particular egress interface, it may be determined which customer is using the particular egress interface. Hence, the customer may be billed for its use of the particular egress interface, as well as for traffic which passes through the particular egress interface.

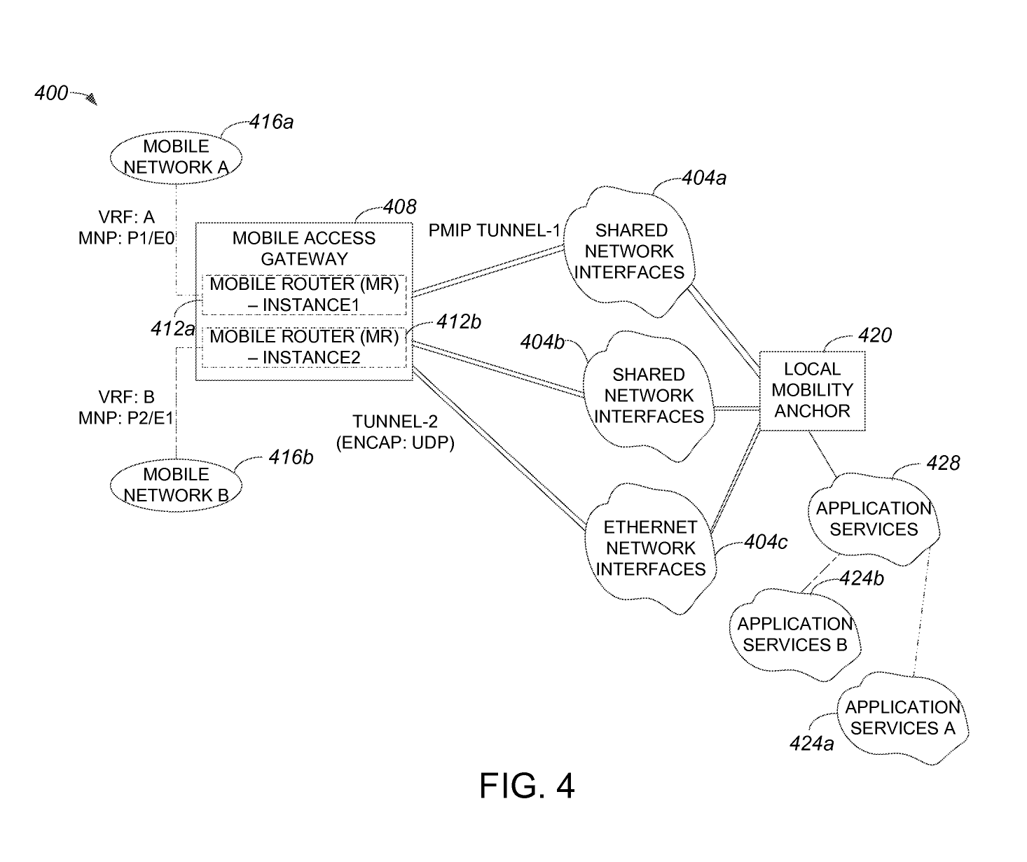

In many overall networks, load balancing may allow the overall networks to operate more efficiently. Sharing egress links between customers generally allows the for application-based load balancing. Multipath support may be provided between a MAG and an LMA such that the MAG may register multiple transport endpoints with the LMA in order to allow multiple tunnels to be established between the MAG and the LMA. With reference to FIG. 4, second overall network that includes a MAG on which logical instances of mobile nodes, e.g., logical instances of mobile routers, are collocated and in which an egress link to application services on a network may be shared for purposes of load balancing will be described in accordance with an embodiment. An overall network 400 includes a MAG 408 that has a logical instance of a mobile router 412a that is associated with a mobile network “A” 416a and a logical instance of a mobile router 412b that is associated with a mobile network “B” 416b. Mobile network “A” 416a has an ingress interface associated with logical instance of mobile router 412a and multiple PMIP tunnels. Mobile network “B” 416b has an ingress interface associated with logical instance of mobile router 412b and multiple PMIP tunnels.

Overall network 400 includes networks 404a-c which each have a shared interface. That is, MAG 408 may use multiple egress interfaces. Each egress interface may be dedicated to a single customer, or shared across customers. In the embodiment as shown, network 404a may include 3G and/or 4G shared interfaces, network 404b may include 3G and/or 4G shared interfaces, and network 404c may include Ethernet shared interfaces. When multiple egress links are shared across customers, traffic associated with a particular customer may be split across substantially all egress links based on any suitable factor, e.g., based on application type. Networks 404a-c may be shared across customers associated with mobile networks 416a, 416b, and application-based load balancing may be applied to determine which networks 404a-c and, hence, which egress links may be used by each customer. Using a selected egress link, customers associated with mobile networks 416a, 416b may access appropriate application services 424a, 424b, 428 through an LMA 420. In one embodiment, MAG 408 may establish a tunnel to LMA 420 over each available path.

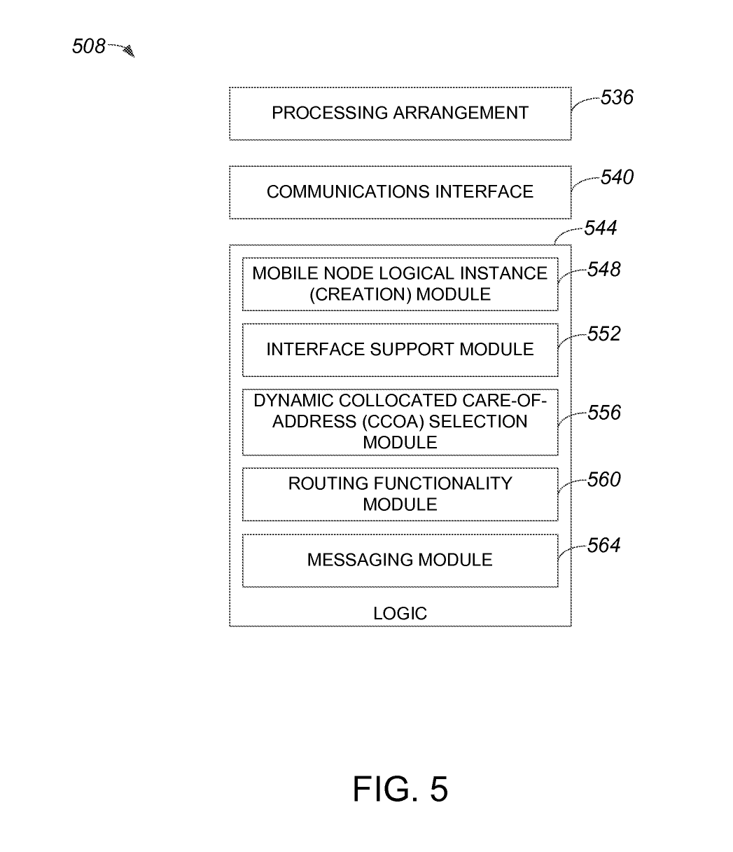

FIG. 5 is a diagrammatic representation of a MAG on which a logical instance of a mobile node may be collocated in accordance with an embodiment. A MAG 508, which may be an access router, includes a processing arrangement 536 that includes at least one processor, and a communications interface 540. Processing arrangement 536 is configured to execute logic 544 included on MAG 508.

Communications interface 540 generally includes at least one input/output (I/O) port that allows MAG 508 to communicate with other elements within a network. Communications interface 540 may be configured such that some interfaces included in communications interface 540 are designated as mobile network interfaces on a customer basis.

Logic 544, which may generally be hardware and/or software logic, includes a mobile node logical instance module 548, an interface support module 552, a dynamic CCOA selection module 556, and a routing functionality module 560. Mobile node logical instance module 548 is arranged to create a logical instance of a mobile node on MAG 508 to support the created logical instance of the mobile node. Interface support module 552 is configured to support physical mobile nodes that are in communication with communications interface 540. Interface support module 552 is also configured to support the configuration of egress interfaces as roaming interfaces and the prioritization of the roaming interfaces associated with communications interface 540. Dynamic CCOA selection module 556 is configured to allow a COA to be dynamically selected based on factors including, but not limited to including, priority and availability. Routing functionality module 560 is generally configured to allow information to be routed through MAG 508.

Logic 544 also includes a messaging module 564. Messaging module 564 is generally configured to create messages that may be forwarded or otherwise transmitted through a network by communications interface 540. For example, messaging module 564 may create a proxy binding update (PBU) for a logical instance of a mobile node created by mobile node logical instance module 548 that identifies the logical instance of the mobile node. The PBU generally includes messaging extensions that allow the logical instance of the mobile node to be identified. It should be appreciated that messaging module 564 may generally send a PBU for the logical instance of the mobile node on an IP subnet configured on a designated mobile network interface that is a party of communications interface 540. The messaging extensions generally identify, but are not limited to identifying, mobile networks, routing context identifiers for customer networks, and the like.

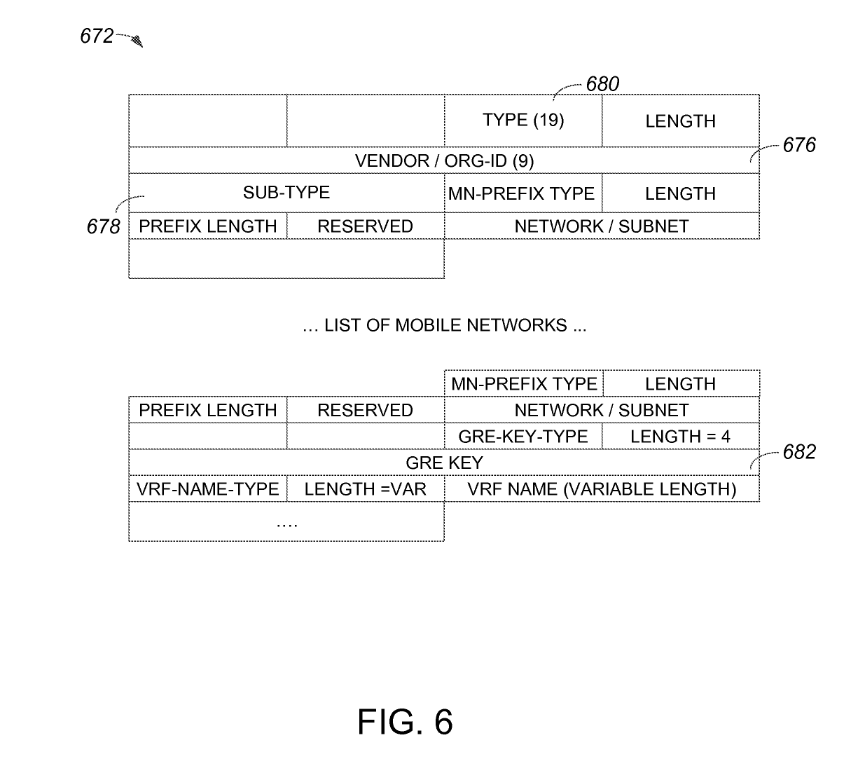

Referring next to FIG. 6, one embodiment of messaging extension for a PBU that may be sent by a MAG that includes at least one logical instance of a mobile node will be described in accordance with an embodiment. A message, e.g., a PBU, 672 which includes extensions that allow a logical instance of a mobile node to be identified is arranged to include fields that are used to specify a number of different variables and/or parameters. It should be understood that when PBU 672 is sent on a network as for example to an LMA associated with a particular logical instance of a mobile node, static IPv4 addresses may be configured on a home interface of a logical mobile node in an IPv4 Home Address Request option. Similarly, when PBU 682 is sent on a network, an IPv6 home prefix may also be carried in PBU 682, e.g., as a Home Network Prefix option.

Among the variables and/or parameters included in message 672 are a vendor or organizational identifier 676 that identifies a vendor. Vendor-specific variables and/or parameters include a sub-type 678 that specifies an extension associated with a vendor identified by vendor identifier 676. In one embodiment, sub-type 678 indicates that existence of a collocated mobile node, or mobile router, and MAG. A type 680 may specify whether a network is associated with IPv4 or IPv6, and a GRE key 682. Other information included in message 672 may include, but is not limited to including, mobile network prefixes and/or routing context identifiers.

In response to receiving message 672 from a MAG, an LMA may set up forwarding to assigned prefixes, and will typically send a proxy binding acknowledgment (PBA) to the MAG. Once a PBA is obtained, the MAG may set up a route for tunneling substantially all traffic associated with a logical instance of a mobile network between the MAG and the LMA, as for example through a MAG-LMA tunnel.

Although only a few embodiments have been described in this disclosure, it should be understood that the disclosure may be embodied in many other specific forms without departing from the spirit or the scope of the present disclosure. By way of example, an egress interface of a MAG has generally been described as being configurable as a MAG roaming interface. A MAG may assign priorities to roaming interfaces, and may identify an available interface with the highest priority for use. A MAG may actively maintain a list of available roaming interfaces, and may be arranged to identify a best available roaming interface as an active roaming interface. An IP address associated with the active roaming interface may be used as a proxy COA, in some instances.

Information identified in a logical mobile node configuration that is enabled on a MAG may vary widely. In general, a logical mobile node configuration may include, but is not limited to including, a mobile node identifier, a MAC address, a designated home interface, and at least one mobile network interface. As will be appreciated by those skilled in the art, mobile networks are generally reachable via a mobile network interface.

As mentioned above, once configured, a logical instance of a mobile node is substantially always present on a MAG until a CLI associated with logical instance of the mobile node is deactivated. It should be appreciated that when a CLI associated with a logical instance of a mobile node is deactivated, a MAG may send a PBU to an LMA for deregistering a corresponding mobility session.

While a mobile node or device for which a logical instance may be created may be a mobile IP device such as a phone or a smartphone. It should be appreciated, however, that a mobile device is not limited to being a phone or a smartphone. In general, a mobile device may be any device which may be moved to different locations and may be assigned an IP address. For example, a mobile device may be a laptop computer, a tablet computer, and/or a digital media player without departing from the spirit or the scope of the present disclosure. In one embodiment, a mobile node may be a mobile router that is attached to a mobile network such as a mobile IP network. An IP network may include any number of IP nodes, and a mobile router may be a gateway that allows the IP nodes to reach other IP networks and/or the Internet. It should be understood that a mobile router and IP networks substantially attached to the mobile router may generally move as a single cluster.

The embodiments may be implemented as hardware, firmware, and/or software logic embodied in a tangible medium that, when executed, e.g., by a processing system associated with a network component or a network node, is operable to perform the various methods and processes described above. That is, the logic may be embodied as physical arrangements, modules, elements, or components. A tangible medium may be substantially any suitable physical, computer-readable medium that is capable of storing logic which may be executed, e.g., by a processing system such as a computer system, to perform methods and functions associated with the embodiments. Such computer-readable media may include, but are not limited to including, physical storage and/or memory devices. Executable logic may include code devices, computer program code, and/or executable computer commands or instructions that may be embodied on computer-readable media.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

What is claimed is:

1. A mobile access gateway (MAG) comprising:
a processor;
a communications interface, the communications interface being configured to communicate with at least one mobile network and at least one local mobility anchor; and
logic, the logic including a mobile node logical instance module and an address selection module, the mobile node logical instance module configured to cooperate with the processor to create a first logical instance of a first mobile node on the MAG, the address selection module being arranged to cooperate with the processor to configure an egress roaming interface for the MAG.

2. The MAG of claim 1 further including:
the first logical instance of the first mobile node, wherein the first logical instance of the first mobile node is identified by a mobile node identifier.

3. The MAG of claim 2 wherein the first logical instance of the first mobile node is a first logical instance of a first mobile router.

4. The MAG of claim 2 wherein the mobile node logical instance module is configured to cooperate with the processor to create a second logical instance of the second mobile node on the MAG, and wherein the MAG further includes:
the second logical instance of the second mobile node.

5. The MAG of claim 4 wherein the at least one mobile network includes a first mobile network and a second mobile network, the first mobile network being associated the first logical instance of the first mobile node, the second mobile network being associated with the second logical instance of the second mobile node.

6. The MAG of claim 2 further including a collocated care-of-address (CCOA) selection module, wherein the CCOA selection module is configured to dynamically select a CCOA for the first logical instance of the first mobile node.

7. The MAG of claim 1 wherein the communications interface includes a first mobile network interface configured to support the least one mobile network, and wherein the communications interface further includes at least the egress roaming interface, and wherein the address selection module is a care-of-address (COA) selection module further configured to select a COA for the egress roaming interface.

8. The MAG of claim 1 wherein the logic further includes a messaging module, the messaging module being arranged to create a proxy binding update for the first logical instance of the first mobile node and to cause the proxy binding update for the first logical instance of the first mobile node to be forwarded by the communications interface

9. Logic embodied in one or more tangible, non-transitory, computer-readable media for execution and, when executed, operable to:
create a first logical instance of a first mobile node on a mobile access gateway (MAG), wherein the first logical instance of the first mobile node is a first collocated entity on the MAG; and
obtain a collocated care-of-address (CCOA) for the first logical instance of the first mobile node.

10. The logic of claim 9 wherein the logic is further operable to:
define an identity for the first logical instance of the first mobile node, wherein the identity includes at least a mobile node identifier.

11. The logic of claim 10 wherein the identity for the first logical instance of the first mobile node further includes a designated home-interface and at least one mobile-network interface.

12. The logic of claim 9 wherein the logic is further operable to:
create a second logical instance of a second mobile node, wherein the second logical instance of the second mobile node is a second collocated entity on the MAG.

13. The logic of claim 12 wherein the logic is further operable to:
cause the first logical instance of the first mobile node and the second logical instance of the second mobile node to share egress links associated with the MAG.

14. The logic of claim 12 wherein the logic is further operable to:
dedicate a first egress link associated with the MAG to the first logical instance of the first mobile node and to dedicate a second egress link associated with the MAG to the second logical instance of the second mobile node.

15. The logic of claim 9 wherein the logic is further operable to:
create a proxy binding update (PBU) for the first logical instance of the first mobile node; and
send the PBU on a network.

16. The logic of claim 9 wherein the first logical instance of the first mobile node is a first logical instance of a first mobile router.

17. A method comprising:
creating a first logical instance of a first mobile node on a mobile access gateway (MAG), wherein the first logical instance of the first mobile node is a first collocated entity on the MAG; and
obtaining a collocated care-of-address (CCOA) for the first logical instance of the first mobile node.

18. The method of claim 17 further including:
defining an identity for the first logical instance of the first mobile node, wherein the identity includes a mobile node identifier and a media access control address.

19. The method of claim 17 further including:
creating a second logical instance of a second mobile node, wherein the second logical instance of the second mobile node is a second collocated entity on the MAG.

20. The method of claim 19 further including:
causing the first logical instance of the first mobile node and the second logical instance of the second mobile node to share egress links associated with the MAG.
